(19) United States
(12) Patent Application Publication
(10) Pub. No.: US 2013/0268735 A1
(43) Pub. Date: Oct. 10, 2013

(54) SUPPORT FOR SPECULATIVE OWNERSHIP WITHOUT DATA

(71) Applicants: Enric Gibert Codina, Sant Cugat Del Valles (ES); Fernando Latorre, Barcelona (ES); Josep M. Codina, Hospitalet de Llobregat (ES); Crispin Gomez Requena, Barcelona (ES); Antonio Gonzalez, Barcelona (ES); Meyrem Hyuseinova, Barcelona (ES); Christos E. Kotselidis, Linz (ES); Pedro Lopez, Molins de Rei (ES); Marc Lupon, Barcelona (ES); Carlos Madriles, Barcelona (ES); Grigorios Magklis, Barcelona (ES); Pedro Marcuello, Barcelona (ES); Alejandro Martinez Vicente, Barcelona (ES); Raul Martinez, Barcelona (ES); Daniel Ortega, Barcelona (ES); Demos Pavlou, Barcelona (ES); Kyriakos A. Stavrou, Barcelona (ES); Georgios Tournavitis, Barcelona (ES); Polychronis Xekalakis, Barcelona (ES)

(72) Inventors: Enric Gibert Codina, Sant Cugat Del Valles (ES); Fernando Latorre, Barcelona (ES); Josep M. Codina, Hospitalet de Llobregat (ES); Crispin Gomez Requena, Barcelona (ES); Antonio Gonzalez, Barcelona (ES); Meyrem Hyuseinova, Barcelona (ES); Christos E. Kotselidis, Linz (ES); Pedro Lopez, Molins de Rei (ES); Marc Lupon, Barcelona (ES); Carlos Madriles, Barcelona (ES); Grigorios Magklis, Barcelona (ES); Pedro Marcuello, Barcelona (ES); Alejandro Martinez Vicente, Barcelona (ES); Raul Martinez, Barcelona (ES); Daniel Ortega, Barcelona (ES); Demos Pavlou, Barcelona (ES); Kyriakos A. Stavrou, Barcelona (ES); Georgios Tournavitis, Barcelona (ES); Polychronis Xekalakis, Barcelona (ES)

(21) Appl. No.: 13/994,686

(22) PCT Filed: Dec. 29, 2011
(86) PCT No.: PCT/US11/67865

§ 371 Date: Jun. 14, 2013

(51) Int. Cl. G06F 12/08

(52) U.S. Cl. CPC G06F 12/0815
USPC 711/141

(57) ABSTRACT

Techniques are described for providing an enhanced cache coherency protocol for a multi-core processor that includes a Speculative Request For Ownership Without Data (SRFOWD) for a portion of cache memory. With a SRFOWD, only an acknowledgement message may be provided as an answer to a requesting core. The contents of the affected cache line are not required to be a part of the answer. The enhanced cache coherency protocol may assure that a valid copy of the current cache line exists in case of misspeculation by the requesting core. Thus, an owner of the current copy of the cache line may maintain a copy of the old contents of the cache line. The old contents of the cache line may be discarded if speculation by the requesting core turns out to be correct. Otherwise, in case of misspeculation by the requesting core, the old contents of the cache line may be set back to a valid state.

### TECHNICAL FIELD

Embodiments described herein generally relate to operation of processors. More particularly, some embodiments relate to cache coherency of memory hierarchy of multi-core processors.

### BACKGROUND ART

In multi-core processors, cache coherency refers to the consistency of data stored in cache memories. When entities, such as processing cores in a multi-core processor system, maintain caches, problems may arise with inconsistent data. For example, if a first processing core has a copy of a cache line from a previous read and a second processing core changes that cache line, without any notification of the change, the first processing core could be left with an invalid cache line. Cache coherence is intended to manage such conflicts and maintain cache memory consistency.

In a multi-core processor system, a basic cache-coherence protocol, such as the MSI (Modified Shared Invalid) protocol, is used to maintain cache coherency. As with other cache coherency protocols, the letters of the protocol name identify the possible states in which a cache line can be. For the MSI protocol, each block (e.g., line) contained inside a cache can have one of three possible states:
Modified: The block has been modified in the cache. The data in the cache is then inconsistent with the backing store (e.g. memory). A cache with a block in the modified state has the responsibility to write the block to the backing store when it is evicted.
Shared: This block is unmodified and exists in at least one cache. The cache can evict the data without writing it to the backing store.
Invalid: This block is invalid, and must be fetched from memory or another cache if the block is to be stored in this cache.

These coherency states are maintained through communication between processing cores, the caches and a backing store. For example, when a core requires a portion of cache, such as a cache line, to perform a write operation, a core may perform a Request For Ownership (RFO) for the cache line. In response, an entity currently owning the cache line responds with an acknowledgement that includes the data contained within the requested cache line and invalidates its own copy.

However, in the case where a core will write to the entire cache line, the core does not need to receive the current contents of the cache line that it plans to overwrite. Receiving the contents of the cache line in this case wastes resources and increases traffic contention on the interconnection network connecting processing cores of the multi-core processor.

Guaranteeing that a core will write to an entire cache line is difficult due to potential exceptions, interrupts or other dynamic events that may occur before the entire cache line has been written. As such, current processors are extremely conservative when requesting a cache line for ownership without data, and apply this optimization very rarely. However, processors that include some sort of speculative support (e.g., transactional memory) are very suited for a more aggressive usage of this optimization. In addition, processors that include some sort of analysis/optimization logic (e.g., support for dynamic binary translation/optimization) may further exploit this optimization.

### BRIEF DESCRIPTION OF THE DRAWINGS

FIG. 1 depicts an example environment 100 of a multi-core processor usable to perform an enhanced cache coherency protocol.

FIG. 2 depicts example cache states of an enhanced cache coherency protocol.

FIG. 3 depicts example processor actions of an enhanced cache coherency protocol.

FIG. 4 depicts example uncore transactions of an enhanced cache coherency protocol.

FIG. 5 depicts example state transitions from a perspective of an uncore of a multi-core processor.

FIG. 6 depicts example state transitions from a perspective of a core processor of a multi-core processor.

FIG. 7 is a flowchart showing an illustrative method for an enhanced cache coherency protocol.

FIG. 8 is a flowchart showing an illustrative method for an enhanced cache coherency protocol.

FIG. 9 is a flowchart showing an illustrative method for an enhanced cache coherency protocol.

FIG. 10 depicts an example environment 1000, usable to perform an enhanced cache coherency protocol over multiple multi-core processors.

### DETAILED DESCRIPTION

### Overview

This disclosure describes sample embodiments of an enhanced cache coherency protocol that includes a Speculative Request For Ownership Without Data (SRFOWD) for a portion of cache memory, such as a cache line. Unlike the current RFO, with a SRFOWD, only an acknowledgement message may be provided as an answer. The contents of the affected cache line are not required to be a part of the answer. This avoids wasting resources transferring data that will be overwritten, thus reducing traffic contention on an interconnection network of a multi-core processor.

As disclosed herein in various embodiments, a core of a multi-core processor may send a SRFOWD when it detects (e.g., speculates) that a set of store operations may overwrite an entire portion of a cache, such as a cache line. However, due to the speculative nature of the request, instead of invalidating the current copy of the cache line, the enhanced cache coherency protocol may assure that a valid copy of the current cache line exists in case of misspeculation by the requesting core. Thus, an owner of the current copy of the cache line may maintain a copy of the old contents of the cache line. The old contents of the cache line may be discarded if speculation by the requesting core turns out to be correct. Otherwise, in case of misspeculation by the requesting core, the old contents of the cache line may be set back to a valid state.

### Illustrative System Architecture

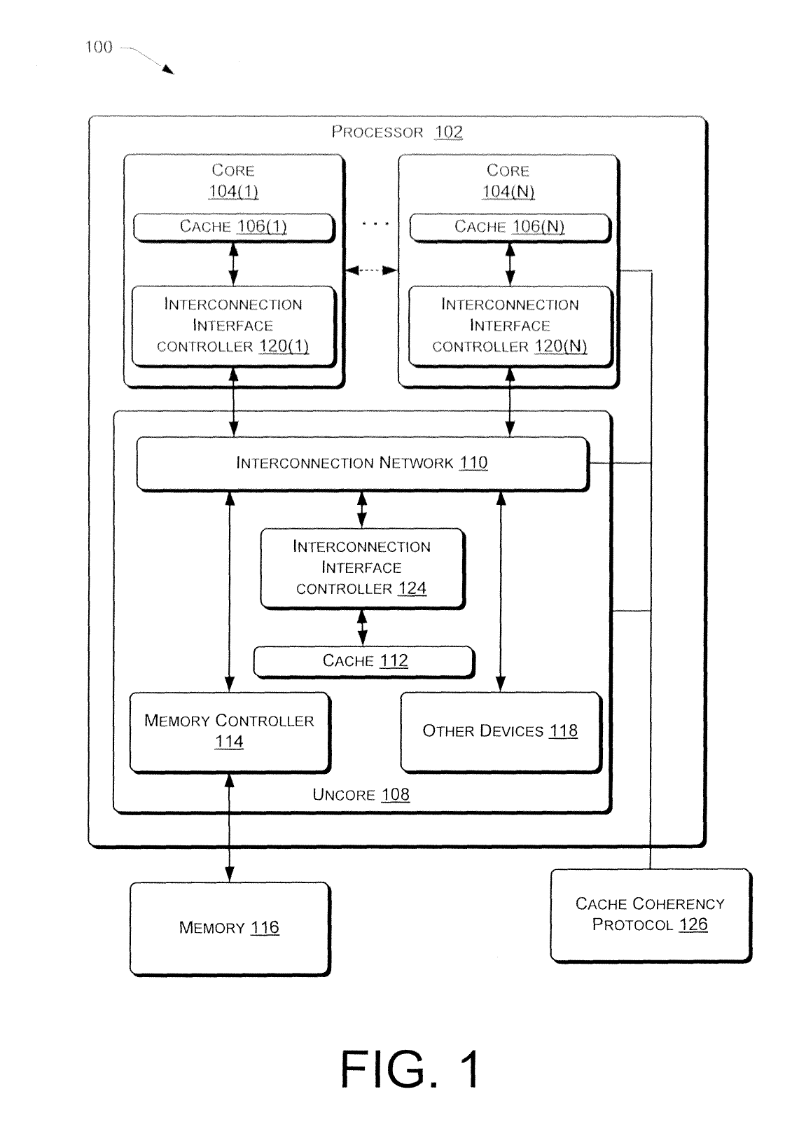

FIG. 1 depicts an example environment 100 usable to perform an enhanced or extended cache coherency protocol. Processor 102 may include a multi-core processor (e.g., multi-core processor on a single integrated circuit die) having one or more processing cores 104(1) to 104(N), each core having logic to implement at least a part of an enhanced cache coherency protocol.

Core 104(1) may have an associated on core cache 106(1). Cache 106(1) may include, for example, cache memory directly accessible by processor core 104(1), such as level 1 (L1) cache, or the like. In an embodiment, cache 106(1) may be considered as a part of core 104(1). For illustrative purposes in FIG. 1, cache 106(1) is illustrated as a single cache, however, it may also include multiple caches within core 104(1).

In a similar manner to core 104(1), core 104(N) may have an associated cache 106(N). Similar to cache 106(1), cache 106(N) may include, for example, cache memory directly accessible by core 104(N), such as L1 cache, or the like. In an embodiment, cache 106(N) may be considered as a part of core 104(N). For illustrative purposes in FIG. 1, cache 106(N) is illustrated as a single cache, however, it may also include multiple caches within core 104(N).

Processor 102 may also include uncore 108. Uncore 108 may include hardware components that are not in a core, but which are essential for performing functions of cores 104(1)-104(N). In an embodiment, uncore 108 may be part of a multi-core chip on a single integrated circuit die that also contains cores 104(1)-104(N).

As an example, uncore 108 may include, but is not limited to, core interconnection network 110, uncore cache 112, memory controller 114 (for controlling access to memory 116 that may be external to processor 102), as well as other uncore devices 118. Cache 112 may include, for example, cache memory accessible by at least one of cores 104(1) through 104(N), such as L2 cache, L3 cache, or the like. For illustrative purposes in FIG. 1, cache 112 is illustrated as a single cache within uncore 108. However, cache 112 may also include multiple caches distributed within uncore 108, one or more caches external to uncore 108, one or more caches external to processor 102, or the like.

Each cache memory in processor 102 may have an associated interconnection interface controller to communicate to other agents of the system and to facilitate implementation of cache coherency protocol 126 as well as cache memory access via interconnection network 110 by, for example, cores 104(1)-104(N). For example, interconnection interface controller 120(1) is attached to cache 106(1) to facilitate connection of cache 106(1) to interconnection network 110. Likewise, interconnection interface controller 120(N) is attached to cache 106(N) and interconnection interface controller 124 is attached to cache 112 to facilitate connection of their associated cache's to interconnection network 110. As an example, interconnection interface controller 120(1) may provide messaging and message translation between core 104(1) and uncore 108 to facilitate cache coherency protocol 126. Likewise, interconnection interface controller 120(N) may provide messaging and message translation between core 104(N) and uncore 108 to facilitate cache coherency protocol 126. As such, interconnection interface controllers 120(1)-120(N) and 124 may observe and/or respond to activity or actions between cores 104(1)-104(N) and uncore 108.

Interconnection network 110 may implement a bus-like interconnection network capability that provides for messaging and data transfer between cores 104(1)-104(N) and uncore 108, as well as components of uncore 108, such as cache 112.

As described herein, since multiple cores may desire ownership of, or access to, various blocks or lines of cache memory, problems may arise with inconsistent data. Thus, processor 102 may implement an enhanced cache coherency protocol, such as cache coherency protocol 126, to assure the validity and availability of portions of cache memory, such as particular cache lines.

As an example, in an embodiment of cache coherency protocol 126, core 104(1) may perform a Speculative Request For Ownership Without Data (SRFOWD) action for a portion of cache memory, such as a cache line having a particular address or index. This SRFOWD action may then be translated by interconnection interface controller 120(1) into an uncore message sent by interconnection interface controller 120(1) to other of cores 104 through the interconnection network 110. The requested cache line may be currently owned by, for example, core 104(N) and resident in cache memory 106(N) of core 104(N) in a modified state. Core 104(N) may then grant ownership of the requested cache line to core 104(1), while maintaining a copy or version of the current cache line tagged with a different (e.g., remote logged) state. Core 104(N) may then provide an acknowledgement of ownership of the current cache line to core 104(1) without providing any of the data contents of the cache line to core 104(1). Core 104(1) may then obtain ownership of the requested cache line in, for example, cache 106(1). In an embodiment, core 104(1) may perform the SRFOWD action in such a manner that core 104(1) speculates that it will perform a complete write of the entire cache line. In an embodiment, if core 104(1) has misspeculated the complete write of the entire cache line, core 104(N) may then transition the copy or version of the current cache line to a valid state. In an embodiment, if core 104(1) successfully completes the write of the entire cache line, core 104(N) may then transition the copy or the version of the current cache line to an invalid state.

As another example, in an embodiment of cache coherency protocol 126, core 104(1) may perform a Request for Ownership (RFO) or a SRFOWD for a cache line resident in cache 112 in a shared state. Other of cores 104 may be holding the requested cache line in, for example, their associated cache 106, in the shared state. In this example, interconnection interface controller 120(1) may translate the RFO or SRFOWD action from core 104(1) into an associated uncore message sent through the interconnection network 110, causing the other of cores 104 to discard or invalidate their copy of the cache line. In an embodiment, core 104(1) may then take ownership and tag the cache line with a different (e.g., speculative) state.

As another example, in an embodiment of cache coherency protocol 126, core 104(1) may perform a Request for Ownership (RFO) or a SRFOWD for a cache line resident in cache 106(1) in a modified state. In this example, the action will cause core 104(1) to tag the cache line with a different (e.g. logged) state and create a new copy or version of the requested cache line in a different (e.g. speculative) state.

For illustrative purposes in FIG. 1, cache coherency protocol 126 is shown as external to uncore 108 and cores 104(1)-104(N). However, in various embodiments, cache coherency protocol 126 may be implemented in whole or in part within any combination of uncore 108, cores 104(1)-104(N) and/or any other part of processor 102.

As an example, cache coherency protocol 126 may be used to facilitate control or modification of contents and a state of a cache line (e.g., a 64 byte block of cache). Cache coherency protocol 126 may be used to respond to a variety of messages or requests (e.g., actions) associated with cores 104(1)-104(N), uncore 108, interconnection interface controllers 120(1)-120(N) and 124, and the like. Cache coherency protocol 126 may also control a variety of state transitions associated with a current state of a cache (e.g., state of a cache line) corresponding to actions associated with at least one of cores 104(1)-104(N) and/or uncore 108. In an embodiment, one or more of core processors 104(1)-104(N) may perform actions that may affect cache coherency protocol 126. Such actions may be translated by cache coherency protocol 126 via, for example, interconnection interface controllers, into transactions, requests and/or messages over uncore 108 that may result in a state transition of a portion of a cache, such as a cache line. Interconnection interface controller 120 may translate a message or action from an associated core 104, and provide an uncore message to at least one of cores 104 in a simultaneous, synchronous or asynchronous manner. In an alternate embodiment, cache coherency protocol 126 may determine, detect or be configured to not provide an uncore message to one or more of cores 104.

Additionally, in an embodiment, one or more of core processors 104(1)-104(N) may perform actions in conjunction with cache coherency protocol 126 that may result in a state transition of a cache line without interaction of uncore 108, such that an interconnection interface controller may not send any uncore message to any of cores 104.

Some examples of common cache coherency protocols include MSI (Modified, Shared and Invalid), MESI (Modified, Exclusive, Shared and Invalid), MOSI (Modified, Owned, Shared and Invalid), MOESI (Modified, Owned, Exclusive, Shared and Invalid), MERSI (Modified, Exclusive, Read Only or Recent, Shared and Invalid), MESIF (Modified, Exclusive, Shared, Invalid and Forward), Synapse, Berkeley, Firefly, Dragon, and the like.

As described herein, embodiments of cache coherency protocol 126 may provide extensions, enhancements, changes and/or modifications to common cache coherency protocols. Some advantages of these extensions, enhancements, changes and/or modifications may include reduced cache misses, reduced traffic and traffic contention on an interconnection network of a multi-core processor and efficient rollback of unsuccessful transactions, to name a few. Such advantages, as well as other advantages, may improve the speed, performance and/or efficiency of multi-core processors.

### Illustrative Cache Line States

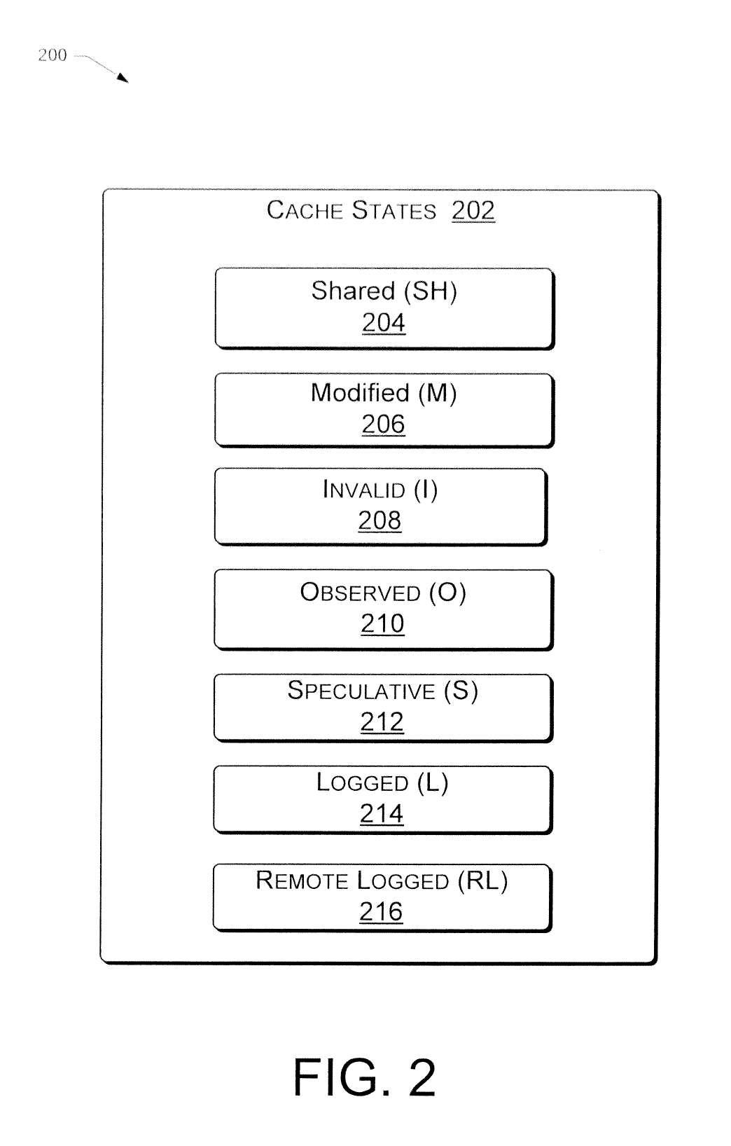

FIG. 2 illustrates examples of cache states 202 in an embodiment of an enhanced cache coherency protocol, for example cache coherency protocol 126. For simplicity, FIG. 2 illustrates cache states 202 that represent, for example, an extension of the MSI cache coherency protocol. However, the states illustrated in FIG. 2, alone or in any combination of features, may be easily applied to extend other cache coherency protocols, such as MESI, MOSI, MOESI, MERSI, MESIF, write-once, Synapse, Berkeley, Firefly, Dragon, or the like.

Cache states 202 relate to various exemplary states of a portion of a cache. In an embodiment, a portion of a cache may include a line or a block of cache comprising an integer number of bytes. In another embodiment, the portion of a cache may include a cache line or block having a non-integer number of bytes or an integer number of bits.

For purposes of simplicity, the portion of cache that may have a particular cache state 202 will be referred to as a cache line. As an example, the portion of cache may be a cache line in any of cache 106(1)-106(N) or cache 112.

FIG. 2 illustrates examples of a cache line in one of cache states 202 to include Shared (SH) 204, Modified (M) 206, Invalid (I) 208, Observed (O) 210, Speculative (S) 212, Logged (L) 214 and Remote Logged (RL) 216.

SH 204 is an example of a shared state. A cache line in state SH 204 may be present (e.g., valid) in a shared and unmodified state. State SH 204 may indicate that the cache contains an up-to-date version of the cache line, and that the cache line may also be present in other core's cache memories in a shared state. A cache line in state SH 204 may indicate that this cache line is stored in multiple caches and that it is “clean”, implying that it matches a copy of the cache line in main memory, such as memory 116. A cache line in state SH 204 may be discarded at any time. As an example, a core 104 cannot write to a cache line in state SH 204 without first requesting ownership of the cache line.

M 206 is an example of a modified state. A cache line in state M 206 may be present in a modified state, such that it contains a stale version of the cache line. For example, a cache line in state M 206 may be considered as dirty, implying that it has been modified from its associated value in main memory. A cache containing a cache line in state M 206 may be required to write the data in the cache line back to main memory at some time in the future, before permitting any other read of the (no longer valid) main memory state. As an example, a core 104 may request ownership of a cache line, the request for ownership is granted, the core 104 then updates the cache line. Once core 104 updates the cache line, the cache line may be in state M 206. No other core 104 may have a clean or dirty copy of a cache line if this cache line is in modified state M 206 in one of the cache memories 106.

I 208 is an example of an invalid state where a cache line is considered to be invalid. A cache line in state I 208 may be considered as a cache line that is not valid or no longer present in the cache.

O 210 is an example of an observed state. For example, state O 210 may imply that the cache line has been speculatively read, by a core 104. Main memory (or cache memory shared by other cores) may contain an up-to-date version of a cache line in state O 210. For example, a cache line may be marked in state O 210 after being read or loaded by a core 104 by a speculative read action. In an embodiment, if a commit or rollback is performed on a cache line in state O 210, the cache line may transition to shared state SH 204.

S 212 is an example of a speculative state. For example, state S 212 may imply that the cache line in a particular cache is present (e.g., valid) and has been (or will be) speculatively modified. Main memory may contain a stale version of the cache line. Other cache memories 106, on the other hand, do not have a valid copy of the cache line. An exception to this is that one, and only one, other cache 106 may contain a copy with the old contents of the cache line in a Remote Logged state, discussed below. As an example, state S 212 may be equivalent to state O 210, except that state S 212 may involve speculative stores (e.g., writes) instead of speculative loads (e.g., reads). In an embodiment, a cache line in speculative state S 212 transitions to the modified state M 206 upon performing a commit, whereas it transitions to an invalid state I 208 upon a rollback.

L 214 is an example of a logged state. In an embodiment, a cache line in state L 214 may be an old copy or version of a corresponding speculative version of a cache line in state S 212.

In an embodiment, Logged state L 214 may be used when a cache line in a Modified state M 206 is written within a transaction by, for example, the same core owning the line in modified state M 206. In this case, the affected cache line is moved to Logged state L 214 and a copy of the cache line is created and tagged in Speculative state S 212. This speculative copy of the cache line may then be updated by write operations within the transaction. If the transaction commits (i.e., the transaction is successful), lines in the Speculative state S 212 may be moved to Modified state M 206, and lines in the Logged state L 214 may be discarded (moved to Invalid state 208). On the other hand, if the transaction rolls back (i.e., the transaction is not successful), lines in the Speculative state S 212 may be discarded (i.e., moved to Invalid state I 208) and cache lines in Logged state L 214 may be moved back to Modified state M 206 to recover the old contents of the cache line. In an embodiment, a cache line in speculative state S 212 always has a clean copy with the old contents somewhere in the system in order to recover the state in case of a rollback. For example, the old contents can be in logged state L 214 in the same cache 106, remote logged in another cache 106, have a copy in cache 112 or main memory.

RL 216 is an example of a Remote Logged state. In an embodiment, a cache line in state RL 216 is an old copy version of a cache line that has been requested to be updated entirely by another core.

In an embodiment, core 104(1) may detect (e.g., speculate) that it will overwrite an entire cache line as part of, for example, executing a transaction. Core 104(1) may perform a SRFOWD and obtain ownership of the cache line from, for example, core 104(N) that had the line in modified state M206. Core 104(N) may then keep a current copy of the cache line in Remote Logged state 216. If core 104(1) is unable to complete the transaction, core 104(N) may restore the cache line marked in Remote Logged state 216 to a valid state (e.g., modified state M 206). If core 104(1) is successful in completing the transaction, core 104(N) may discard the cache line in Remote Logged state 216 by moving it to Invalid state 208.

Thus, using the exemplary states described above, example environment 100 will have a mechanism to detect violations and will provide support to recover the old contents of a cache line.

### Illustrative Processor Actions

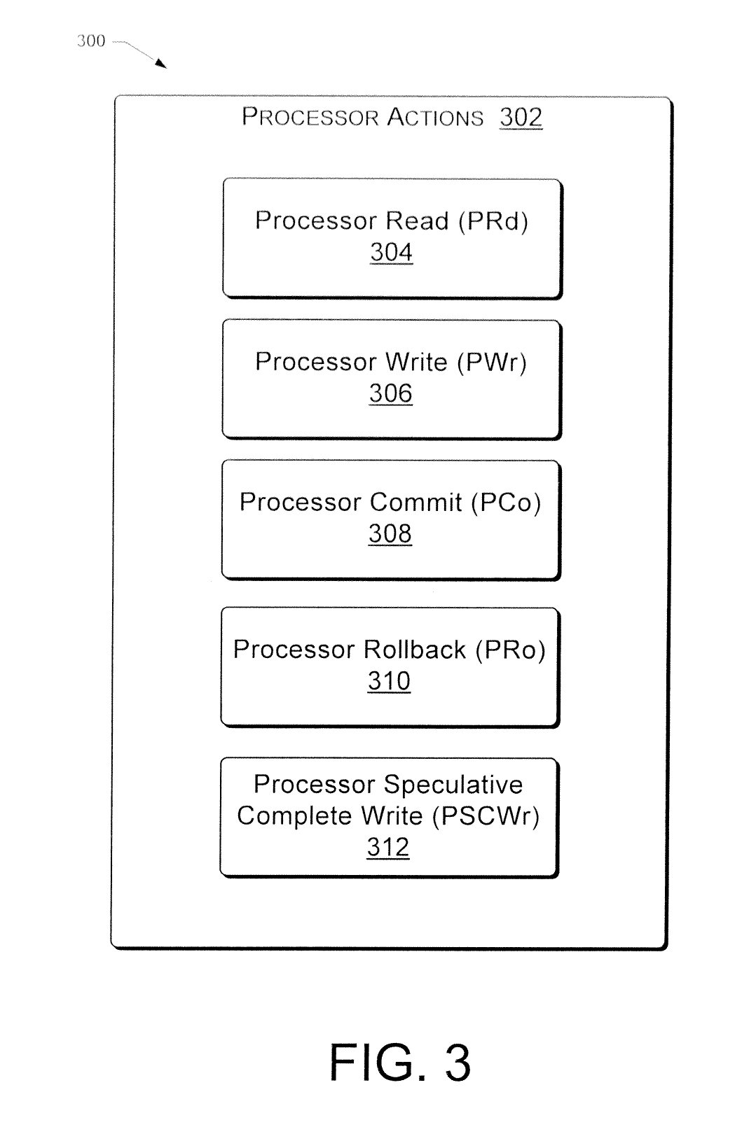

FIG. 3 illustrates example environment 300 having processor actions 302 that may be performed in support of cache coherency protocol 126. For example, processor actions 302 may be performed by one or more of processor cores 104(1)-104(N) to affect cache coherency protocol 126.

Example processor actions 302 may include Processor Read (PRd) 304, Processor Write (PWr) 306, Processor Commit (PCo) 308, Processor Rollback (PRo) 310 and Processor Speculative Complete Write (PSCWr) 312. In an embodiment, example processor actions 302 may be performed by one or more of processor cores 104. In an embodiment, example processor actions 302 may be performed during the execution of a transaction by a processor core. However, in an alternate embodiment, example processor actions 302 may be performed within a transaction, outside of a transaction, or a combination of within and outside of a transaction. In the forthcoming description it is assumed, for clarity purposes, that these actions are executed within a transaction. Hence, in an embodiment, Processor Read (PRd) 304, Processor Write (PWr) 306 and Processor Speculative Complete Write (PSCWr) 312 are speculative actions due to the speculative nature of transactions. One skilled in the art can easily devise the extensions required to describe the actions for processor actions executed outside of a transaction.

Action Processor Read (PRd) 304 indicates that a processor core has executed a load instruction that reads a memory location. Depending on the state of an associated cache line(s), cache coherence protocol 126 may need to be informed. PRd 304 may be used to inform cache coherence protocol 126 that a processor core has executed a read instruction.

Action Processor Write (PWr) 306 indicates that a processor core has executed a store instruction that writes into a memory location. Depending on the state of an associated cache line(s), cache coherence protocol 126 may need to be informed. PWr 306 may be used to inform cache coherence protocol 126 that a processor core has executed a write instruction.

Action Processor Commit (PCo) 308 indicates that a processor core commits a currently executed transaction. PCo 308 may be used to inform cache coherence protocol 126 that a processor core has executed a commit instruction.

Action Processor Rollback (PRo) 310 indicates that a processor core may roll back a currently executed transaction. PRo 310 may be used to inform cache coherence protocol 126 that a processor core has executed a rollback instruction. As an example, an interrupt, a memory violation, or some other event may prevent a processor core from completing the execution of a transaction. In this case, the processor may need to notify other cores that the transaction did not succeed. One or more of these other cores may be holding an old copy of a cache line associated with the transaction, and as such, they may need to act accordingly and rollback the old cache line copy.

Action Processor Speculative Complete Write (PSCWr) 312 indicates that a processor core speculates that it is going to overwrite a portion of a cache, such as an entire cache line (i.e., write speculatively to a cache line). As such, other cores may need to be informed about this action. PSCWr 312 may be used to inform cache coherence protocol 126 that a processor core has executed a speculative complete write instruction. In an embodiment, action PSCWr 312 is equivalent to a Speculative Request For Ownership Without Data (SRFOWD).

As an example, a processor core may speculate that it will write a complete cache line. In this case, the processor core may send a speculative request for ownership without data for the cache line, for example, in the form of action PSCWr 312. In an embodiment, if required, cache coherence protocol 126 may then facilitate generation of an associated message in uncore 108, to notify cores 104 of this action.

### Illustrative Uncore Transactions

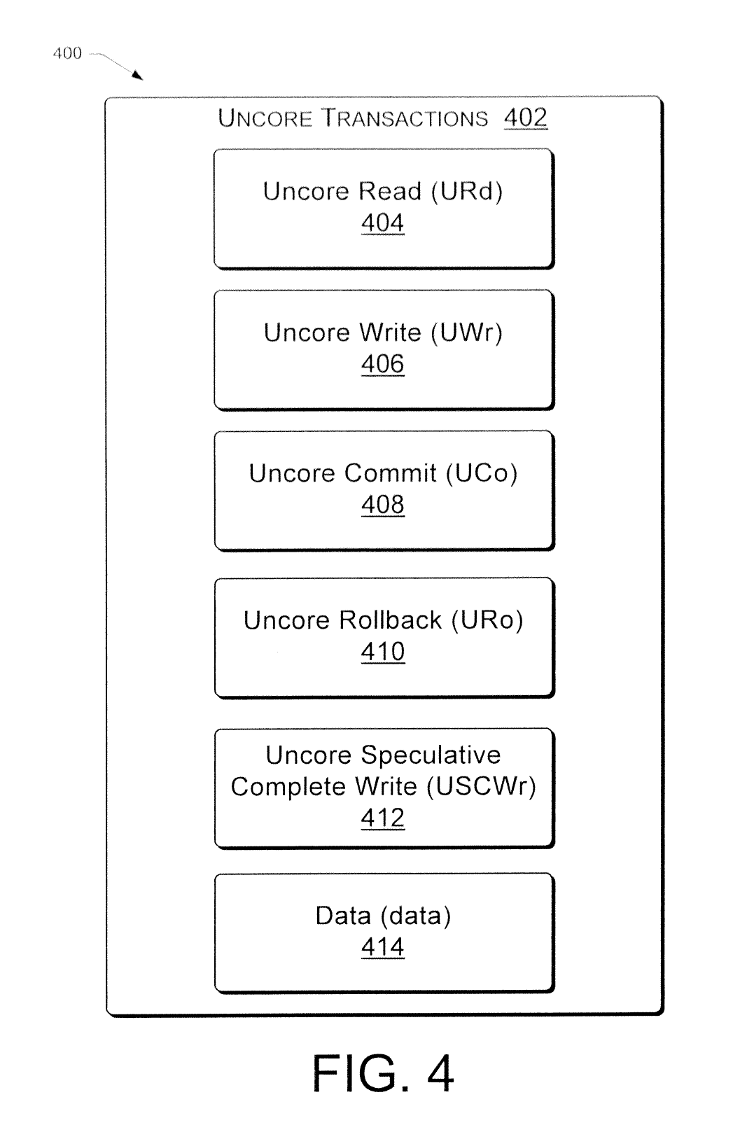

FIG. 4 illustrates example environment 400 having uncore transactions 402 that may be performed in support of cache coherency protocol 126. As an example, processor actions 302 may be translated into uncore transactions 402 that occur over uncore 108.

Example uncore transactions 402 may include Uncore Read (URd) 404, Uncore Write (UWr) 406, Uncore Commit (UCo) 408, Uncore Rollback (URo) 410, Uncore Speculative Complete Write (USCWr) 412 and Data (data) 414.

Uncore Read (URd) 404 informs other cores that a cache line has been, or is going to be read. Depending on the state of a cache line, a PRd 304 action executed by a processor may generate a URd 404 message over uncore 108.

Uncore Write (UWr) 406 informs other cores that a cache line has been, or is going to be written. Depending on the state of a cache line, a PWr 306 action may generate a UWr message over the uncore.

Uncore Commit (UCo) 408 informs other cores, for example, that a core is committing its transaction. A UCo 408 message may include an identified (ID) of the core that is performing the commit.

Uncore Rollback (URo) 410 informs other cores, for example, that a core is rolling back its transaction. Such a message may include the ID of the core that is performing the roll back.

Uncore Speculative Complete Write (USCWr) 412 informs other cores that a processor is requesting a cache line for ownership without data in a speculative manner. Depending on the state of the cache line, action PSCWr 312 executed by a core may imply sending USCWr 412 message over the uncore. Such a message may include the ID of the core that is performing the SRFOWD action.

Data (data) 414 is an uncore transaction in which one of the cores (or main memory) responds with the contents of, for example, a cache line.

### Illustrative Cache Coherency State Transitions

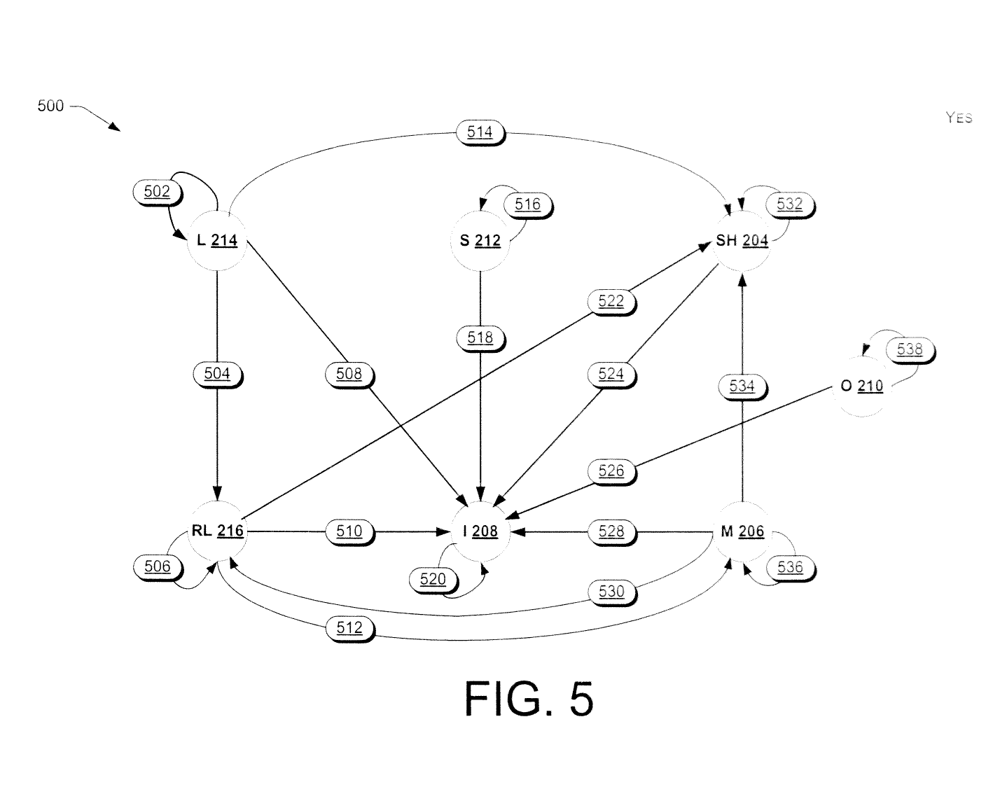

FIG. 5 illustrates example environment 500 showing state transitions 502-538 of cache states 202 in cache coherency protocol 126 from the perspective of, for example, interconnection interface controllers 120 in uncore 108. Each state transition 502-538 may be identified as a Message (i.e., first component of a Message/Response pair) observed in uncore 108, and a Response (i.e., second component of a Message/Response pair), if any, generated by the corresponding state transition.

Table 1 illustrates example associations between state transitions 502-538 of FIG. 5 and associated Uncore Message/Response pairs.

TABLE 1
State Transitions from Perspective of Core Interconnection Interface

| State Transition | Uncore Message/Response Pairs |
|---|---|
| 502 | UCo 408/— |
| | URo 410/— |
| 504 | USCWr 412/URo 410 |
| 506 | USCWr 412/— |
| 508 | UWr 406/URo 410 + data 414 |
| 510 | UCo 408/— |
| | UWr 406/data |
| 512 | URo 410/— |
| 514 | URd 404/URo 410 + data 414 |
| 516 | UCo 408/— |
| | URo 410/— |
| 518 | URd 404/URo 410 |
| | UWr 406/URo 410 |
| | USCWr 412/URo 410 |
| 520 | URd 404/— |
| | UWr 406/— |
| | UCo 408/— |
| | URo 410/— |
| | USCWr 412/— |
| 522 | URd 404/data 414 |
| 524 | UWr 406/— |
| | USCWr 412/— |
| 526 | UWr 406/URo 410 |
| | USCWr 412/URo 410 |
| 528 | UWr 406/data 414 |
| 530 | USCWr 412/— |
| 532 | URd 404/— |
| | UCo 408/— |
| | URo 410/— |
| 534 | URd 404/data 414 |
| 536 | UCo 408/— |
| | URo 410/— |
| 538 | URd 404/— |
| | UCo 408/— |
| | URo 410/— |

In FIG. 5, each state transition 502-538 may be identified with a Message observed in uncore 108 (e.g., the Message part of the Message/Response pair) and an associated Response (e.g., the Response part of the Message/Response pair).

To illustrate this, state transition 530 (i.e., a transition from state M 206 to state RL 216) in FIG. 5 is associated with the following Uncore Message/Response pair in Table 1:

USCWr 412/-

In this Uncore Message/Response pair, USCWr 412 (i.e., an Uncore Speculative Complete Write) is a message observed in the uncore, while the response part of the Uncore Message/Response pair which is generated by state transition 530 is denoted by “-”, which implies a “do nothing else” in uncore 108.

As an example, in state transition 530, USCWr 412 may be a message observed in uncore 108 by one or more of core processors 104. This USCWr 412 message may be in response to one of core processors 104 executing a PSCWr 312 (Processor Speculative Complete Write) action, indicating that the core processor “speculates” that it may write to a complete cache line, as part of execution of, for example, a transaction. Assuming the cache line is currently in modified state M 206 in a cache of a different core than the one executing the write, the state of the cache line will transition to Remote Logged state RL 216. The response to this state transition 530 is indicated in Table 1 as “-”, implying that the response to state transition 530 may be to do nothing else.

In an embodiment, regarding state transition 530, a first processing core having ownership of the cache line may make a copy of the cache line and tag the cache line with state RL 216 in response to observing message USCWr 412 associated with a second processing core. The first processing core may also associate an identifier (ID) of the second processing core with the cache line in state RL 216. The first core may also relinquish ownership of the cache line to the second core by providing an acknowledgement without any data of the cache line copy and maintain the cache line copy in state RL 216.

As another example, state transition 512 (i.e., a transition from state RL 216 to state M RL 216) in FIG. 5 is associated in Table 1 with the following Uncore Message/Response pair:

URo 410/-

In this Uncore Message/Response pair, URo 410 (i.e., an Uncore Rollback) is a message observed in the uncore, while the response part of the Uncore Message/Response pair, which is generated by state transition 512, is denoted by “-”, which implies a “do nothing else” response. Thus, state transition 512 may imply that a cache line in state RL 216 will transition to state M 206 in response to an uncore message URo 410 associated with the cache line and observed via uncore 108.

Thus, in an embodiment, a first core maintaining a copy of the cache line in state RL 216 associated with an ID of a second core, may move the copy of the cache line back to state M 206 upon observing a URo 410 (i.e., Uncore Rollback) message associated with the second core over uncore 108.

As another example, in FIG. 5, state transition 524 indicates a transition from a shared state SH 204 to an Invalid state I 208. In Table 1, state transition 524 is associated with the following Uncore Message/Response pairs:

UWr 406/-

USCWr 412/-

Therefore, state transition 524 of FIG. 5 is associated in Table 1 with either a UWr 406 (i.e., Uncore Write) transaction, and do nothing else (depicted by “-”) in response, or a USCWr 412 (i.e., Uncore Speculative Complete Write) transaction, and do nothing else in response.

Thus, in this example, core processors holding a cache line in Shared state SH 212 that observe either transaction UWr 406 or USCWr 412 over uncore 108 may move that cache line to the Invalid state I 208, with no further action taken in response to this state transition 524.

As another example, in FIG. 5, state transition 504 indicates a transition from a logged state L 214 to a remote logged state RL 216. In Table 1, state transition 504 is associated with the following Uncore Message/Response pair:

USCWr 412/URo 410

State transition 504 of FIG. 5 is associated in Table 1 with a USCWr 412 (i.e., Uncore Speculative Complete Write) transaction, and a URo 410 (i.e., Uncore Rollback) response generated in response to state transition 504.

In an embodiment regarding state transition 504, a first core may be holding a cache line in logged state L 214 as well as an associated new cache line in speculative state S 212, used for updating by the first core. A second core may perform a speculative request for ownership without data (e.g., execute action PSCWr 312) for the cache line in logged state L 214. The first core may detect a USCWr 412 message associated with the second core's request, and move the cache line in logged state L 214 to remote logged state RL 216 and the new version of the cache line in speculative state S 212 to invalid state I 208. A rollback message URo 410 may be generated as a response to state transition 504, communicating to other cores that the first core has performed a rollback because a conflict in the transaction executed in both cores has been detected.

As another example, in FIG. 5, state transition 514 indicates a transition from a logged state L 214 to a shared state SH 204. In Table 1, state transition 514 is associated with the following Uncore Message/Response pair:

URd 404/URo 410+data 414

State transition 514 of FIG. 5 is associated in Table 1 with a URd 404 (i.e., Uncore Read) transaction, and a URo 410 (i.e., Uncore Rollback) plus data 414 response generated in response to state transition 514.

In an embodiment regarding state transition 514, a first core may be holding a cache line in logged state L 214 as well as an associated new cache line in speculative state S 212, used for updating by the first core. A second core may perform a read (e.g., execute action PRd 304) for the cache line in logged state L 214. The first core may detect a URd 404 message associated with the second core's read, and move the cache line in logged state L 214 to shared state SH 204 and the new version of the cache line in speculative state S 212 to invalid state I 208. A rollback message URo 410 along with the data (i.e., data 414 requested by the read) may be generated as a response to state transition 514, communicating to other cores that the first core has performed a rollback because a conflict in the transaction executed has been detected.

As another example, in FIG. 5, state transition 508 indicates a transition from a logged state L 214 to an invalid state I 208. In Table 1, state transition 508 is associated with the following Uncore Message/Response pair:

UWr 406/URo 410+data 414

State transition 508 of FIG. 5 is associated in Table 1 with a UWr 406 (i.e., Uncore Write) transaction, and a URo 410 (i.e., Uncore Rollback) plus data 414 response generated in response to state transition 508.

In an embodiment regarding state transition 508, a first core may be holding a cache line in logged state L 214 as well as an associated new cache line in speculative state S 212, used for updating by the first core. A second core may perform a write (e.g., execute action PWr 306) for the cache line in logged state L 214. The first core may detect a UWr 406 message associated with the second core's write, and move the cache line in logged state L 214 to invalid state I 208 and the new version of the cache line in speculative state S 212 to invalid state I 208. A rollback message URo 410 along with the data (i.e., data 414 requested by the write) may be generated as a response to state transition 508, communicating to other cores that the first core has performed a rollback because a conflict in the transaction executed has been detected.

As another example, in FIG. 5, state transition 526 indicates a transition from a observed state O 210 to an invalid state I 208. In Table 1, state transition 526 is associated with the following Uncore Message/Response pair:

UWr 406/URo 410

USCWr 412/URo 410

In an embodiment regarding state transition 526, a first core may be holding a cache line in observed state O 210. A second core may perform a write (e.g., execute action PWr 306) or a speculative write (e.g., execute action PSCWr 312 306) for the cache line in observed state O 210. The first core may detect a UWr 406 or USCWr 412 message associated with the second core's write, and move the cache line in observed state O 210 to invalid state I 208. A rollback message URo 410 may be generated as a response to state transition 526, communicating to other cores that the first core has performed a rollback because a conflict in the transaction executed has been detected.

Other of state transitions 502-538 not addressed above may be interpreted in a similar manner as described in the above examples.

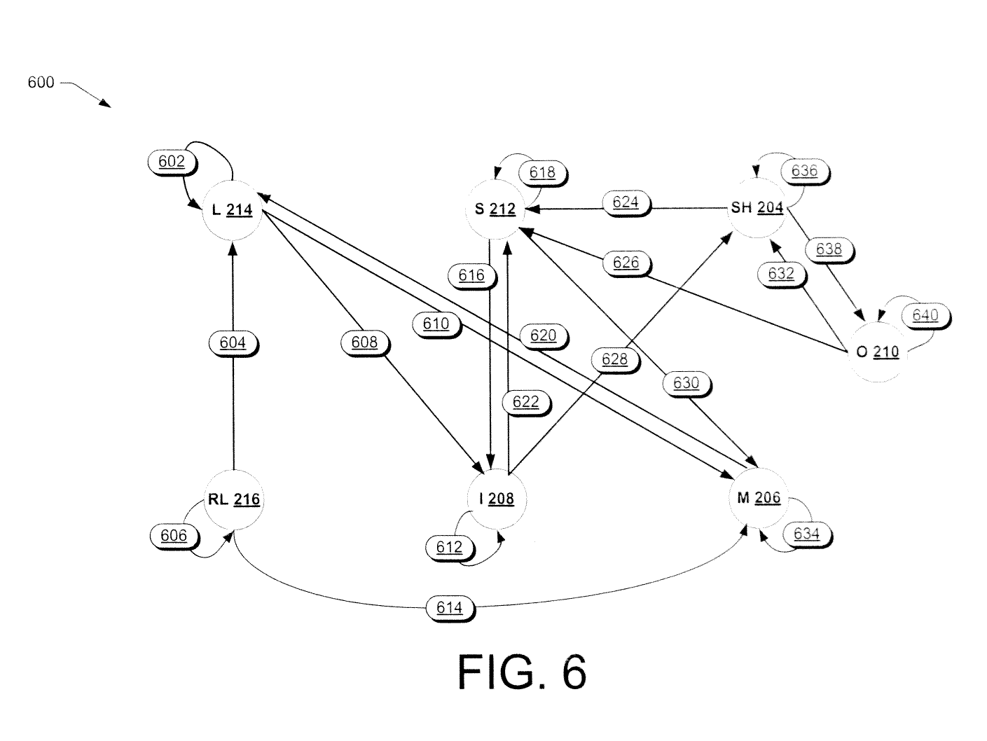

FIG. 6 illustrates example environment 600 showing, as an example, state transitions 602-640 of cache states 202 in cache coherency protocol 126 from the perspective of a core processor, such as one or more of processing cores 104. Each state transition 602-640 may be identified as a core processor Action (i.e., first component of a Processor Action/Response pair) executed by a core processor, and a Response message (i.e., second component of a Processor Action/Response pair), if any, generated in the uncore in response to a corresponding state transition.

Table 2 illustrates example associations between state transitions 602-640 of FIG. 6 and associated Processor Action/Response message pairs.

TABLE 2
State Transitions from Perspective of Core Processor(s)

| State Transition | Processor Action/Response Pairs |
|---|---|
| 602 | PSCWr 312/— |
| | PWr 306/— |
| | PRd 304/— |
| 604 | PWr 306/UWr 406 |
| | PSCWr 312/USCWr 412 |
| 606 | PCo 308/— |
| | PRo 310/— |
| 608 | PCo 308/— |
| 610 | PRo 310/— |
| 612 | PCo 308/— |
| | PRo 310/— |
| 614 | PRd 304/URd 404 |
| 616 | PRo 310/URo 410 |
| 618 | PWr 306/— |
| | PRd 304/— |
| | PSCWr 312/USCWr 412 |
| 620 | PSCWr 312/— |
| | PWr 306/— |
| 622 | PWr 306/UWr 406 |
| | PSCWr 312/USCWr 412 |
| 624 | PWr 306/UWr 406 |
| | PSCWr 312/USCWr 412 |
| 626 | PWr 306/UWr 406 |
| | PSCWr 312/USCWr 412 |
| 628 | PRd 304/URd 404 |
| 630 | PCo 308/UCo 408 |
| 632 | PCo 308/— |
| | PRo 310/— |
| 634 | PCo 308/— |
| | PRd 304/— |
| | PRo 310/— |
| 636 | PCo 308/— |
| | PRd 304/— |
| | PRo 310/— |
| 638 | PRd 304/— |
| 640 | PRd 304/— |

In FIG. 6, each state transition 602-640 may be identified with a processor Action (e.g., the Action part of the Processor Action/Response pair) and a generated Response message (e.g., the Response part of the Processor Action/Response pair), if any, in the uncore.

As an example, state transition 620 (i.e., a transition from state M 206 to state L 214) in FIG. 6 is associated with the following Processor Action/Response pairs in Table 2:

PSCWr 312/-

PWr 306/-

In these Processor Action/Response pairs, PSCWr 312 (i.e., a Processor Speculative Complete Write) and PWr 306 (i.e., a Processor Write) are actions of the Processor Action/Response pairs which may be performed by a core processor, while the response part of each of the Processor Action/Response pairs which are generated by state transition 620 is denoted by “-”, which implies a “do nothing”.

In an embodiment of state transition 620 in FIG. 6, a core processor 104 may execute a PSCWr 312 action associated with the cache line. This action may indicate that the core processor speculates that it may write to the entire cache line by, for example, successfully completing a transaction.

As shown in state transition 620 in FIG. 6, assuming the cache line is in Modified state M 206 in the cache 106 of the core 104 executing the write, the cache line would transition to logged state L 214. The response to this transition is indicated in Table 2 as “-”, implying that the response to state transition 620 may be to do nothing else. This means that there is no need to send a message over the uncore to notify the other agents as a response to the action, since the action has been solved locally within the core executing the write.

In an embodiment, a core processor may move the cache line to state L 214 while also creating a copy of the cache line tagged in Speculative state S 212. The core processor may then perform writes to the copy of the cache line in speculative state S 212 while maintaining the original cache line logged in state L 214. In another embodiment, the core processor may perform writes to the copy of the cache line in speculative state S 212 as part of executing a transaction that the core processor speculates will write to the entire cache line.

As another example, in FIG. 6, state transition 610 indicates a transition from a logged state L 214 to a modified state M 206. In Table 2, state transition 610 is associated with the following Processor Action/Response pair:

PRo 310/-

Therefore, state transition 610 of FIG. 6 is associated in Table 2 with a PRo 310 (i.e., Processor Rollback) action, and a do nothing else (depicted by “-”) response. In an embodiment, a core processor may detect that it may not be able to complete a transaction that has generated a cache line in logged state L 214, and execute a PRo 310 action. This may then cause state transition 610 to occur, whereby the cache line in state L 214 is rolled back to modified state M 206.

As another example, in FIG. 6, state transition 630 indicates a transition from a speculative state S 212 to a modified state M 206. In Table 2, state transition 630 is associated with the following Processor Action/Response pair:

PCo 308/UCo 408

Therefore, state transition 630 of FIG. 6 is associated in Table 2 with a PCo 308 (i.e., Processor Commit) action, and a UCo 408 (i.e., Uncore Commit) response message generated over the uncore.

In an embodiment, a core processor may execute a commit action PCo 308 regarding a cache line tagged in state S 212, which causes the cache line to be moved from state S 212 to state M 206 as part of state transition 630.

In another embodiment, a core processor may execute a commit action PCo 308 affecting a cache line tagged in state S 212 in response to detecting successful completion of a transaction, which causes the cache line to be moved from state S 212 to state M 206 as part of state transition 630. In yet another embodiment, a core processing unit may maintain an original copy of the cache line tagged in state S 212 in a logged state L 214.

As another example, in FIG. 6, state transition 616 indicates a transition from a speculative state S 212 to an Invalid state I 208. In Table 2, state transition 616 is associated with the following Processor Action/Response pair:

PRo 310/URo 410

Therefore, state transition 616 of FIG. 6 is associated in Table 2 with a PRo 310 (i.e., Processor Rollback) action, and a URo 410 (i.e., Uncore Rollback) response message generated over the uncore, such as uncore 108.

In an embodiment, a core processor may execute a rollback action PRo 310 regarding a cache line tagged in state S 212, which causes the cache line to be moved from state S 212 to state I 208 as part of state transition 616. In another embodiment, a core processor may execute a rollback action PRo 310 affecting a cache line tagged in state S 212 in response to detecting that a transaction will not successfully complete, which causes the cache line to be moved from state S 212 to state I 208 as part of state transition 616. In yet another embodiment, a core processor may maintain an original copy of the cache line tagged in state S 212 in a logged state L 214, such that when the cache line tagged in state S 212 is discarded, the original copy of the cache line still exists in logged state L 214. Such a copy in logged state L 214 transitions, in this case, to modified state M 206, as described previously.

As another example, in FIG. 6, state transition 608 indicates a transition from a logged state L 214 to an invalid state I 208. In Table 2, state transition 608 is associated with the following Processor Action/Response pair:

PCo 308/-

Therefore, state transition 608 of FIG. 6 is associated in Table 2 with a PCo 308 (i.e., Processor Commit) action, and a do nothing else (depicted by “-”) response.

In an embodiment, a core processor may execute a commit action PCo 308 regarding a cache line tagged in state L 214, which causes the cache line to be moved from state L 214 to state I 208 as part of state transition 608. In another embodiment, a core processor may execute a commit action PCo 308 affecting a cache line tagged in state L 214 in response to detecting successful completion of a transaction, which causes the cache line to be moved from state L 214 to state I 208 as part of state transition 608.

As another example, in FIG. 6, state transition 624 indicates a transition from a shared state SH 204 to a speculative state S 212. In Table 2, state transition 624 is associated with the following Processor Action/Response pair:

PWr 306/UWr 406

PSCWr 312/USCWr 412

Therefore, state transition 624 of FIG. 6 is associated in Table 2 with a PWr 306 (i.e., Processor Write) action, and a UWr 406 (i.e., Uncore Write) response, or a PSCWr 312 (i.e., Processor Speculative Complete Write) action, and a USCWr 412 (i.e., Uncore Speculative Complete Write) response.

In an embodiment, a core processor may execute a speculative write (e.g, write speculatively) regarding a cache line tagged in state SH 204, which causes the cache line to be moved from state SH 204 to speculative state S 212 as part of state transition 624.

Other of state transitions 602-640 not addressed above may be interpreted in a similar manner as described in the above examples.

FIGS. 5 and 6 may be drawn together, with solid lines for processor actions (FIG. 6) and dotted lines for uncore transactions (FIG. 5). FIGS. 5 and 6 have been split herein for clarity purposes.

Note that FIGS. 1-6 have been used to describe various embodiments of cache coherency protocol 126. However, these embodiments are not meant to limit the scope of cache coherency protocol 126, as there are additional alternative embodiments.

As an example of an alternate embodiment, a core may not always be required to inform other cores whether the current transaction commits or rolls back. As an example, a first core may need to inform other cores that it has performed a commit or rollback in order for the other cores to invalidate a cache line in state RL 216 and tagged with the core ID of the first core. Hence, a core executing a PCo 308 or PRo 310 action may need to have a UCo 408 or URo 410 message generated only if it has previously caused a USCWr 412 message to be sent over the uncore during, for example, a current transaction involving the cache line. Thus, by selectively filtering commit and rollback messages, commit and roll back transactions can be avoided over the uncore.

Additionally, the speculative nature of the Speculative Request For Ownership Without Data (SRFOWD) transaction regarding a cache line may imply that a processing core may not be sure whether a transaction is going to commit or not. As an example, the processing core may know for sure that if the transaction successfully completes, the entire cache line will be updated. However, in an embodiment, cache coherency protocol 126 may be extended by forcing a rollback (e.g., URo 410) when an otherwise successful transaction fails to update the entire cache line. In other words, a rollback may be generated in the case of partial write to a cache line requested through a USCWr 412 transaction, even if the associated transaction completes successfully and the processing core performs a commit. In an alternate embodiment, cache coherency protocol 126 may be extended by forcing a rollback to occur when an otherwise successful transaction fails to update entirely all cache lines speculatively requested for ownership without data by a processing core, for example, as part of a transaction.

As example of another alternate embodiment, as shown in state transaction 518 in FIG. 5, a cache line in shared state SH 204 may be moved to invalid state I 208 in state transaction 524 when another core issues a USCWr 412 transaction over uncore 108. However, in an alternate embodiment, that cache line may be moved to a new state called a Shared Log state (not shown). If the other core then commits an associated transaction, associated cache lines in the Shared Log state may be moved to invalid state I 208. If the other core rolled back the transaction, Shared Logged lines may be moved back to Shared state SH 204. This would allow the core owning the cache line in the Shared Logged state to access the cache line without requiring extra uncore transactions in case of a roll back.

As another example, when a core 104 causes generation of an uncore transaction 402 over uncore 108, other cores 104 may observe and service the transaction immediately. For instance, a core 104 executing a PRd 304 action over a cache line in a remote logged state RL 216, as shown in state transition 614 of FIG. 6, may cause the cache line to immediately transition to modified state M 206. However, in an alternate embodiment, this transition may not be immediate. Cores 104 may be “self-snooped” (e.g., a core may receive the same associated message over the uncore). As an example, if a first processing core 104 executes a PRd 304 action over a cache line in state RL 216, a URd 404 message may be sent over uncore 108, but the message may leave the cache line in state RL 216. Upon receiving its own URd 404 message, as shown in state transition 522 in FIG. 5, the first processing core 104 may proceed by sending the corresponding cache line data over the uncore (e.g., updating main memory 116 or the cache memory shared by all the cores) and transitioning the cache line to shared state SH 204.

As another example, a core 104 may exectute actions, such as processor actions 302, within a transaction as described above. However, in an alternate embodiment, a core 104 may distinguish between a read executed within a transaction and a read executed outside a transaction. Thus, new processor actions may be defined as, for example, a PRd (processor speculative read) action for a read within a transaction and a PURd (processor un-transactional read) action for a processor read outside of a transaction, this latter being a non-speculative read operation. The same may apply for writes and complete-line writes. Thus, new processor actions may be defined as, for example, a PWr (processor speculative write) action for a speculative write within a transaction, a PUWr (processor un-transactional write) action for a processor write outside of a transaction, this latter being a non-speculative write operation, a PSCWr (processor speculative complete write) for a complete speculative write within a transaction and a PUCWr (processor complete un-transactional write) action for a processor write outside of a transaction, with PCWr being analogous to the action that generates a “request for ownership without data”. The transitions between the states in this case may be easily extended.

### Illustrative Protocol Operation

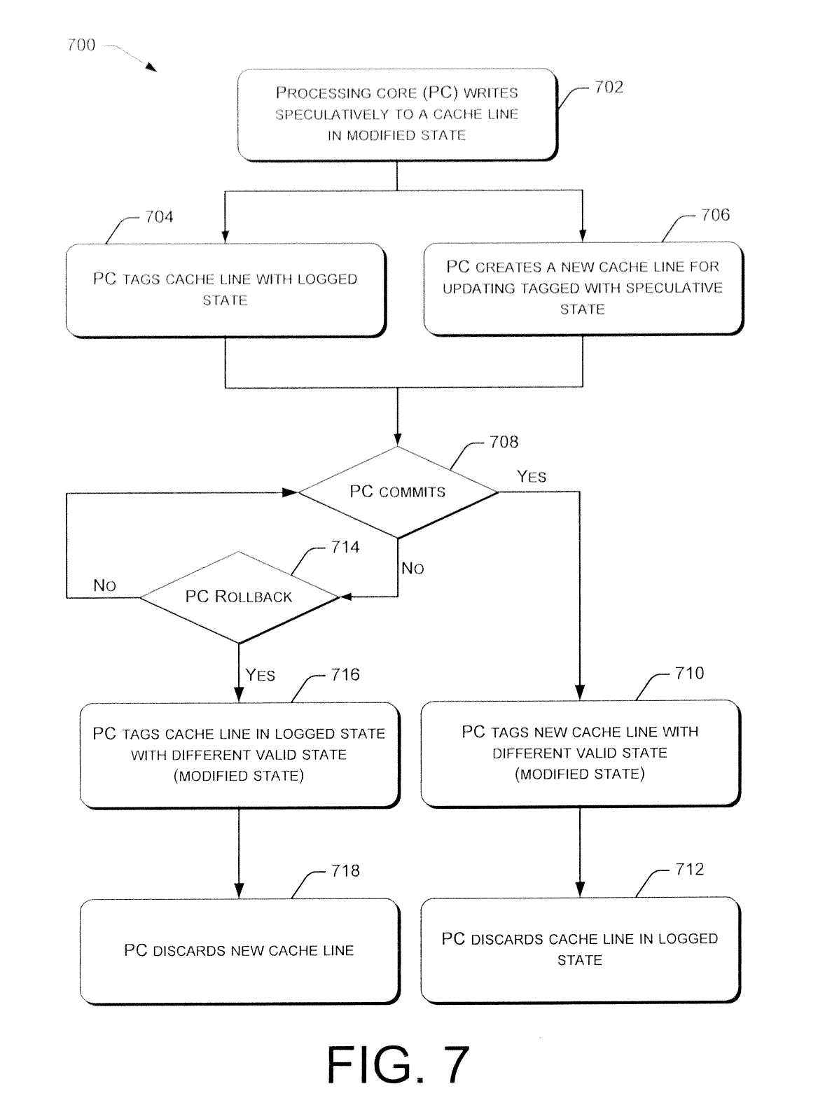

FIGS. 7-9 are example flowcharts illustrating various aspects of an extended cache coherency protocol described herein.

FIG. 7 is a flowchart showing an illustrative method 700 that includes aspects of the cache coherency protocol where a core processing unit writes speculatively to a portion of cache memory, such as a cache line.

At 702, a processing core, such as one of cores 104, performs a speculative write to cache memory. In an embodiment, the processing core may speculate it will write an entire cache line. In another embodiment, a processing core may speculate it will write to an entire cache line in a modified state M 206 as part of executing a transaction. As an example, a processing core may speculate that it will write an entire cache line because the processing core is currently unable to guarantee whether a current transaction is going to commit or not.

At 704, the processing core transitions the cache line to a logged state, such as logged state L 214. As an example, when the processing core has a line in Modified state M 206 and it executes a PWr 306 or PSCWr 312 action, the cache line is moved to the Logged state L 214 to indicate that it is an old copy of the cache line for a local transaction.

At 706, the processing core creates a new cache line and tags the new cache line with a speculative state. In an embodiment, if the processing core executes a PWr 306 action, the new cache line may be a new copy of the cache line created in speculative state S 212 and updated by store instructions within a transaction. In the case of the processing core executing a PSCWr 312 action, the new cache line may be a new version of the cache line created in speculative state S 212, and updated by store instructions within a transaction. In an embodiment, the processing core may direct any updates (e.g., stores, writes) to the new portion, such as the cache line in speculative state S 212. The difference between a PWr 306 and a PSCWr 312 action in this case is that if the processing core executes a PSCWr 312 action, the new cache line does not need to be a copy of the cache line. However, in a different embodiment, the new cache line may be a copy of the cache line such that the new version of the cache line may be a copy of the cache line.

As an example, if a processing core executes a PWr 306 or PSCWr 312 action to a cache line that is in a Shared state S 212, this may cause a UWr 406 or USCWr 412 transaction, respectively, to be sent over the uncore, moving the cache line to speculative state S 212.

At 708, the processing core may execute a commit action, such as PCo 308. In an embodiment, a processing core may perform a PCo 308 if a transaction is successful. This may cause a UCo 408 transaction having an identifier (i.e., ID) of the processing core to be sent over uncore 108. At 710, the cache line is moved to a different valid state (e.g., M 206). As an example, in response to a commit action, the cache line may move from speculative state S 212 to modified state M 206. As a result, the cache line tagged in the logged state may no longer need to be maintained. Thus, at 712, the processing core may discard the cache line tagged in the logged state by, for example, tagging it with invalid state I 208.

If the processing core does not perform a commit action at 708, at 714, the processing core may execute a rollback action, such as PRo 310. In an embodiment, if a transaction is not successful, the processing core may execute a rollback action. The rollback action may result in a rollback message, such as URo 410, along with an ID of the processing core to be sent over uncore 108. In response to a rollback action, at 716, the processing core may change the state of the cache line tagged in the logged state to a different valid state. As an example, the processing core may change the state of the cache line tagged in the logged state L 214 to modified state M 206. At 718, in response to the rollback action, the processing core may discard the new cache line tagged in the speculative state by, for example, tagging it with invalid state I 208.

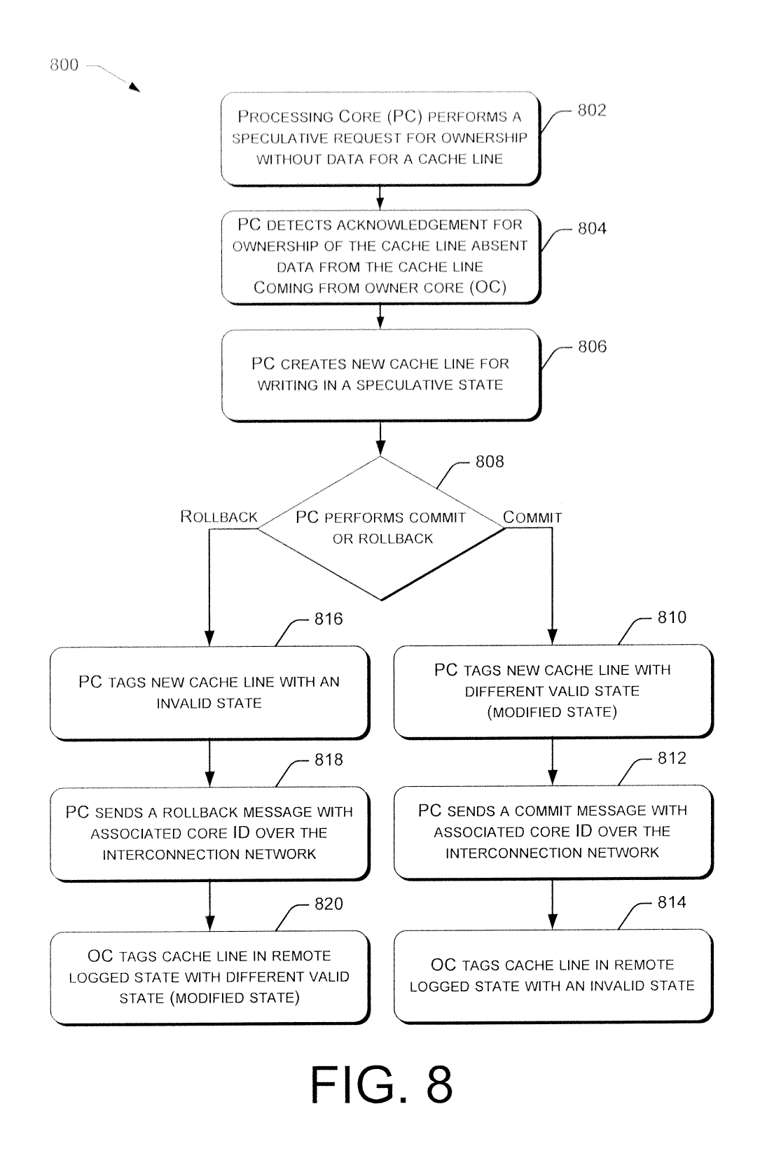

FIG. 8 is a flowchart showing an illustrative method 800 that includes aspects of a cache coherency protocol where a processing core performs a speculative request for ownership without data for a cache line.

At 802, in an embodiment, a processing core may execute a PSCWr 312 action requesting ownership without data for a cache line. PSCWr 312 action may cause a USCWr 412 message that includes the ID of the processing core to be sent over uncore 108. As an example, the processing core may speculate that it will write to a portion of cache memory, such as an entire cache line. Since the processor speculates it will overwrite an entire cache line, there is no need for the processor to receive any data associated with the cache line. Thus, any entity (e.g., an Owner Core) owning the requested cache line does not need to send any data associated with the cache line to the processing core. Thus, in an embodiment, a processing core executing a PSCWr 312 action requests ownership for a cache line without data contained in the cache line being provided.

At 804, the processing core detects an acknowledgement for ownership of the cache line, where the acknowledgement does not contain any data from the cache line coming from the Owner Core (OC). Additionally, the OC makes a copy of the cache line tagged in remote logged state RL 216. As an example, an OC that currently owns the cache line, for example, a different processing core 104, in response to the PSCWr 312 action executed by the processing core, merely returns an acknowledgement granting the processing core ownership of the cache line in response to the request for ownership. Stated another way, in response to a USCWr 412 message detected over uncore 108, an OC that currently owns the cache line merely returns an acknowledgement to the processing core having the ID in the USCWr 412 message, granting the processing core ownership of the requested cache line. The acknowledgement is absent any data content from the cache line.

At 806, the processing core may create a new cache line tagged with a speculative state, such as state S 212. The new cache line may be either a new copy or a new version of the cache line.

At 808, it is determined whether the processing core performs a commit or a rollback. In an embodiment, the processing core may commit a transaction by executing a PCo 308, or roll a transaction back by executing a Pro 310.

If at 808, the processing core performs a commit, at 810, the processing core may tag the new cache line with a different valid state. As an example, the processing core may change the new cache line from speculative state S 212 to modified state M 206. At 812, the processing core sends a commit message with an associated core ID over interconnection network 110. At 814, the OC discards the cache line tagged in the remote logged state by, for example, changing the cache line's state to I 208.

On the other hand, if at 808 the processing core performs a rollback, at 816, the processing core tags the new cache line previously tagged in the speculative state with an invalid state. At 818, the processing core sends a rollback message with an associated core ID over interconnection network 110. At 820, the OC tags the cache line held in state RL 216 with a valid state (e.g., M 206).

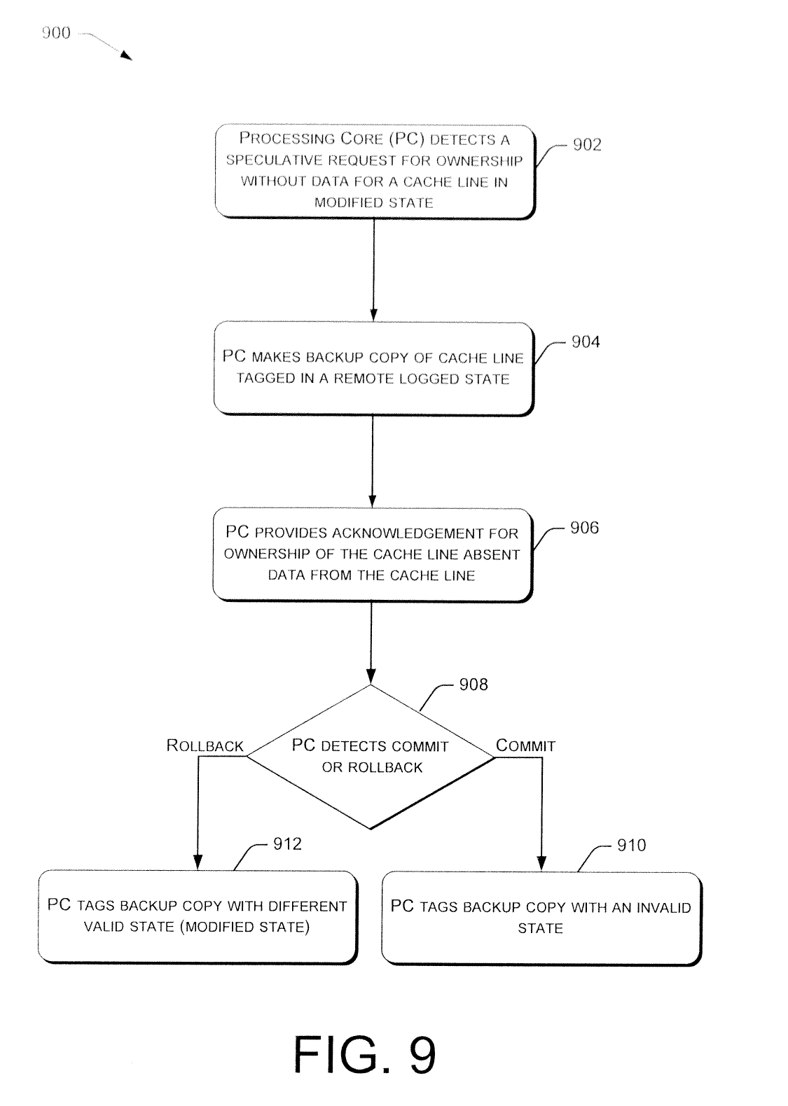

FIG. 9 is a flowchart showing an illustrative method 900 that includes aspects of the cache coherency protocol where a processing core detects a speculative request for ownership without data for a cache line.

At 902, in an embodiment, a first processing core may detect message USCWr 412 containing an id of a requesting second processing core requesting ownership without data for a cache line over uncore 108. As an example, the requesting second processing core may have executed action PSCWr 312 requesting ownership without data for an entire cache line. Since the requesting second processing core speculates it will overwrite an entire cache line, there is no need for the first processing core to send any data associated with the cache line.

At 904, an entity that owns the requested cache line (in modified state M 206), such as a first processing core 104, makes a backup copy of the requested cache line and tags it in a remote logged state, such as state RL 216, along with the id of the requesting second processing core.

At 906, the first processing core provides an acknowledgement for ownership of the cache line to the second processing core. In an embodiment, the acknowledgement is provided by the first processing core to the second processing core without any data contained in the cache line. At this point, ownership of the cache line passes to the requesting entity. As an example, the acknowledgement is provided to the second processing core at the id in message USCWr 412 detected over uncore 108 absent any data contained in the cache line.

At 908, the first processing core detects whether the second processing core has performed a commit or rollback associated with the requested cache line. If at 908, the first processing core detects that the second processing core has performed a commit, then at 910 the first processing core discards the backup copy by, for example, changing its state from RL 216 to invalid state I 208.

On the other hand, if at 908 the first processing core detects that the second processing core has performed a rollback associated with the requested cache line, then at 912, the first processing core tags the backup copy of the cache line with a different valid state. As an example, the first processing core may change the state of the backup copy of the cache line from RL 216 to state M 206, or any other valid state.

As an example of another embodiment (not shown in FIG. 9), the first processing core may detect a second USCWr 412 message containing an id of, for example, a third processing core requesting ownership without data for the cache line in a speculative manner. In this example, the first processing core will keep the cache line in remote logged state RL 216 and record the id of the third processing core. The second processing core will observe the second USCWr 412 message over uncore 108 and will rollback its transaction by moving its associated cache line in speculative state S 212 to invalid state I 208 as shown in state transition 518 in FIG. 5, and an associated URo 410 message will be sent over uncore 108.

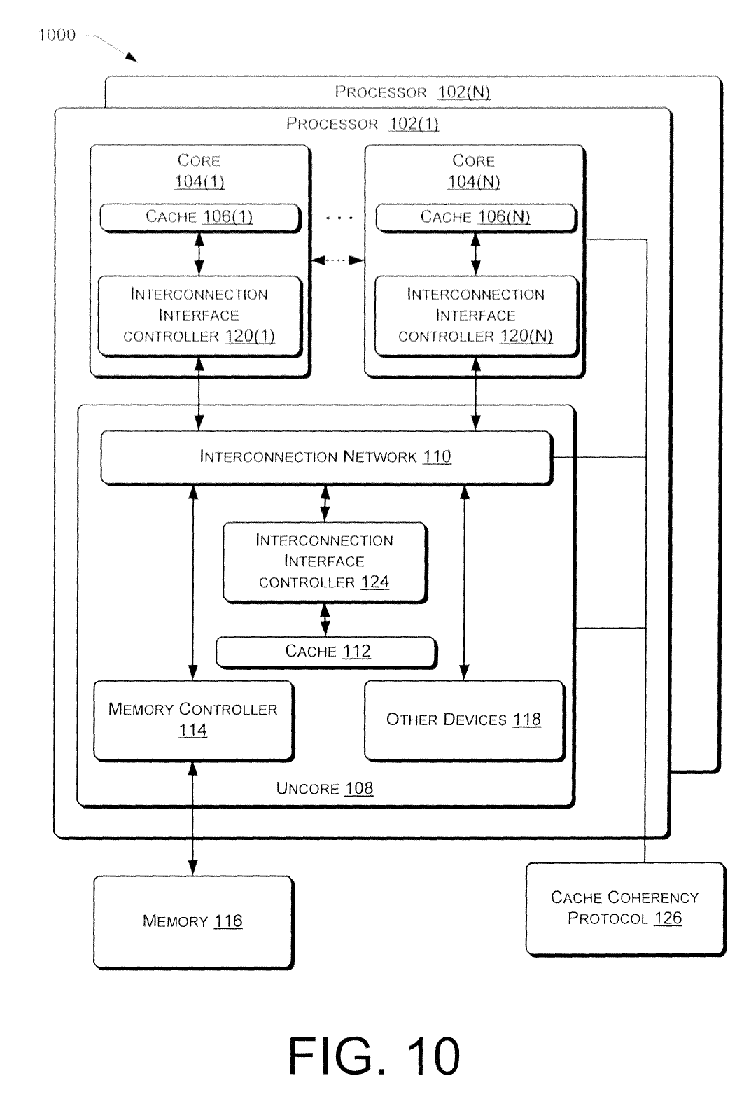

FIG. 10 depicts an example environment 1000 usable to perform an enhanced or extended cache coherency protocol that includes multiple multi-core processors. In environment 1000, cache coherency protocol 126 as described herein may be extended to provide cache coherency over multiple processors 102(1)-102(N), N being an integer number greater than one.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

For instance, all optional features of an apparatus or processor described above may also be implemented with respect to the method or process described herein. Specifics in the examples may be used anywhere in one or more embodiments.

1. A processor comprising:
a processing core having logic to:
write speculatively to a portion of cache memory;
create a copy of the portion of cache memory; and
update the copy.

2. The processor of claim 1, wherein the processing core having logic to tag the copy with a speculative state.

3. The processor of claim 1, wherein the processing core having logic to execute a commit associated with the copy.

4. The processor of claim 3, wherein the processing core having logic to tag the copy with a different valid state based in part on the commit.

5. The processor of claim 4, wherein the processing core having logic to discard the portion of cache memory based in part on the commit.

6. The processor of claim 1, wherein the processing core having logic to tag the portion of cache memory in a logged state.

7. A processor comprising:
a processing core having logic to perform a speculative request for ownership without data for a cache line.

8. The processor of claim 7, wherein the processing core having logic to detect an acknowledgement for ownership of the cache line absent data from the cache line.

9. The processor of claim 7, wherein the processing core having logic to:
tag the cache line with a logged state;
create a new version of the cache line; and
tag the new version with a speculative state.

10. The processor of claim 9, wherein the processing core having logic to perform a write to the new version.

11. The processor of claim 9, wherein the processing core having logic to:
perform a commit associated with the new version;
change the speculative state of the new version to a valid state; and
change the logged state of the cache line to an invalid state.

12. The processor of claim 9, wherein the processing core having logic to:
perform a rollback associated with the cache line in the logged state;
change the state of the new version to an invalid state; and
change the state of the cache line in the logged state to a valid state.

13. The processor of claim 7, further comprising one or more other processing cores that hold a valid copy of the cache line having logic to make a backup copy of the valid copy of the cache line in response to detection of the speculative request for ownership without data.

14. The processor of claim 13, wherein the one or more other processing cores having logic to detect the speculative request for ownership without data over an uncore of the processor.

15. The processor of claim 13, wherein the one or more other processing cores having logic to:
tag the backup copy with a remote logged state; and
tag the backup copy with an identifier of the processing core.

16. The processor of claim 13, wherein the one or more other processing cores having logic to:
detect a commit associated with the cache line and an identifier of the processing core; and
discard the backup copy based in part on the commit.

17. A processor comprising:
a processing core having logic to:
detect a speculative request for ownership without data for a cache line; and
create a copy of the cache line.

18. The processor of claim 17, wherein the processing core having logic to tag the copy with a remote logged state.

19. The processor of claim 17, wherein the processing core having logic to:
detect a rollback action associated with the cache line; and
tag the copy with a different valid state.

20. The processor of claim 17, wherein the processing core having logic to:
detect a commit action associated with the cache line; and
tag the copy with an invalid state.
